(19) United States
(12) Patent Application Publication
(10) Pub. No.: US 2015/0310809 A1
(43) Pub. Date: Oct. 29, 2015

(54) BACKLIGHT DEVICE AND CONTROL METHOD THEREOF

(71) Applicant: SAMSUNG ELECTRO-MECHANICS CO., LTD., Suwon-Si (KR)

(72) Inventors: Je Hyuk RYU, Suwon-Si (KR); Byung Joo Hong, Suwon-Si (KR)

(73) Assignee: SAMSUNG ELECTRO-MECHANICS CO., LTD., Suwon-Si (KR)

(21) Appl. No.: 14/612,236

(22) Filed: Feb. 2, 2015

(30) Foreign Application Priority Data
Apr. 23, 2014 (KR) 10-2014-0048511

(51) Int. Cl. G09G 3/34; G09G 3/32; G09G 3/36

(52) U.S. Cl. CPC G09G 3/3406; G09G 3/3611; G09G 3/32; G09G 2320/0247; G09G 2320/0646

(57) ABSTRACT

A method of controlling a backlight device for generating a synchronization signal of the backlight device using a light emitting diode (LED) may include obtaining a reference synchronization signal, obtaining an average synchronization signal based on the reference synchronization signal, determining error information based on at least one of the reference synchronization signal and the average synchronization signal, and outputting an output synchronization signal based on the average synchronization signal in accordance with the error information.

### CROSS-REFERENCE TO RELATED APPLICATION

This application claims the priority and benefit of Korean Patent Application No. 10-2014-0048511, filed on Apr. 23, 2014, with the Korean Intellectual Property Office, the disclosure of which is incorporated in its entirety herein by reference.

### BACKGROUND

Some embodiments of the present disclosure may relate to a backlight device outputting light to display an image using a vertical synchronization signal, and a control method thereof.

Recently, a growth has been made in the area of flat panel backlight devices. Such flat panel backlight devices are widely used in mobile devices in which miniaturization and low power consumption are required, as well as in large digital TVs in which reductions in weight and thickness are required. Here, a liquid crystal display (LCD) scheme is a most commonly used scheme among flat panel display schemes, because it may be used in a wide range of devices, from small to large devices.

Since a liquid crystal panel does not autonomously emit light, LCD devices require a light source, known as a backlight unit, to be mounted on a rear surface of the liquid crystal panel. A screen may be viewed from the outside while light generated from the backlight unit passes through a liquid crystal layer, a color filter, and the like. Therefore, the backlight unit may have a significant effect on the performance of an LCD device. For example, the backlight unit may have a significant effect on screen quality such as color reproducibility, maximum brightness, contrast ratio, white balance, color temperature, as well as weight, design, life span, power consumption, and the like.

As existing backlight units, a cold cathode fluorescent lamp (CCFL), an external electrode fluorescent lamp (EEFL), and the like are widely used. However, such fluorescent lamps may have large dimensions, consume large amounts of power, and have significant limitations on maximum brightness. Such LCD devices containing the above-mentioned fluorescent lamps exhibit color reproducibility of about 80% at maximum, based on National Television System Committee (NTSC) standards. In particular, since such fluorescent lamps are linear light sources, they may only supply a uniform amount of light to an entire surface of the LCD in the case that a relatively expensive diffusion film, or the like, is used. In addition to the above-mentioned technical factors, there has been a need to develop light sources, other than fluorescent lamps, as can be seen by the use of CCFL in vehicles prohibited by the EU since 2006, and the like.

Meanwhile, although light emitting diodes (LEDs) were not initially able to provide a sufficient amount of brightness to allow for the use thereof in backlights, and are relatively expensive to manufacture, the LEDs having sufficiently high levels of brightness as well as low power consumption and low manufacturing costs have recently been developed. In the case of configuring an array by white LEDs or using an array in which three primary color (RGB) LEDs are appropriately arranged, such an array may function like a surface light source. Accordingly, the backlight unit may be manufactured to include the above-mentioned LED array. Since the backlight unit does not use a relatively expensive diffusion film, or the like, and does not require an inverter, unlike in the case of the fluorescent lamp, the manufacturing costs thereof may be reduced, enlargement while reducing thickness and weight thereof may be facilitated reduced, and the power consumption may also be reduced. In addition, since the backlight unit has a high level of brightness, the color reproducibility thereof based on the NTSC standards may be up to 110%, that is, an amount of color reproducibility unable to be obtained by the CCFL.

Since the LED backlight unit is configured of a number of LEDs and light emission thereof is performed by the LEDs, performance of the LED backlight unit is determined based on methods of driving the respective LEDs.

Meanwhile, the backlight unit may generate various pulse width modulation (PWM) signals in order to improve TV image quality. Examples of representative methods for improving TV image quality include local dimming technology, scanning dimming technology, and the like.

Local dimming technology is a technology in which the backlight is divided into unit blocks having a predetermined size, and each unit block may be individually adjusted in response to an input image thereto. The local dimming technology is a technology in which, in a case in which an image corresponding to each unit block of the backlight is bright, brightness of a corresponding unit block is increased, and in a case in which an image corresponding to each unit block is dim, brightness of a corresponding unit block is decreased, thereby maximizing a brightness difference between a bright portion and a dim portion.

Scanning dimming technology is introduced to eliminate disadvantages occurring due to driving characteristics of the LCD. Existing cathode ray tube (CRT) TVs use phosphors having very small crystal grains which emit light through the impact of an electronic beam. Due to such impulsive characteristics of the CRT TVs, a phosphor decay may occur fairly briefly therein, whereby after-images do not remain in images of a succeeding image frame. However, the LCDs are driven in a hold type manner in which an ON-state is constantly maintained in a case in which power is applied. Therefore, when a screen changes, brightness of a previously displayed image may have an effect on a current image, due to a delay in a liquid crystal response of the LCD. Due to the above-mentioned LCD response characteristics, in a case in which the backlight is driven simultaneously as the LCD, a motion blur phenomenon in which an after-image remains when an image changes to another image may occur. In other words, such a motion blur phenomenon prominently occurs in moving pictures. In order to remove the motion blur phenomenon, various technologies for reducing a moving picture response time (MPRT) have been introduced.

### RELATED ART DOCUMENTS

Korean Patent Laid-Open Publication No. 10-2007-0017906

Korean Patent Laid-Open Publication No. 10-2006-0094452

### SUMMARY

Some embodiments of the present disclosure may provide a backlight device and a control method thereof capable of preventing a flicker phenomenon.

Some embodiments of the present disclosure may also provide a backlight device and a control method thereof capable of being synchronized with an image board.

Some embodiments of the present disclosure may also provide a backlight device and a control method thereof capable of obtaining a synchronization signal less affected by noise.

According to an aspect of the present disclosure, a method of controlling a backlight device for generating a synchronization signal the backlight device using a light emitting diode (LED) may include: obtaining a reference synchronization signal; obtaining an average synchronization signal based on the reference synchronization signal; determining error information based on at least one of the reference synchronization signal and the average synchronization signal; and outputting an output synchronization signal based on the average synchronization signal in accordance with the error information.

The obtaining of the average synchronization signal may include obtaining the average synchronization signal based on a plurality of pieces of period information in the reference synchronization signal.

The obtaining of the average synchronization signal may include obtaining third period information of the average synchronization signal based on first period information and second period information in the reference synchronization signal.

The determining of the error information may include determining whether or not the average synchronization signal is present in a preset range or period.

The outputting of the output synchronization signal may include outputting the output synchronization signal based on at least one of an average synchronization signal of a previous period and a preset synchronization signal in a case in which the average synchronization signal is absent in the preset range.

The determining of the error information may include comparing the reference synchronization signal and the average synchronization signal with each other.

The outputting of the output synchronization signal may include advancing an occurrence timing of the average synchronization signal in a case in which an occurrence timing of the average synchronization signal is subsequent to an occurrence timing of the reference synchronization signal.

The outputting of the output synchronization signal may include retarding an occurrence timing of the average synchronization signal in a case in which an occurrence timing of the average synchronization signal is prior to an occurrence timing of the reference synchronization signal.

According to another aspect of the present disclosure, a backlight device for generating a synchronization signal of an image display device using a LED may include: a reference synchronization signal obtaining unit obtaining a reference synchronization signal; an average synchronization signal obtaining unit obtaining an average synchronization signal based on the reference synchronization signal; a controlling unit determining error information based on at least one of the reference synchronization signal and the average synchronization signal; and a synchronization signal outputting unit outputting an output synchronization signal based on the average synchronization signal in accordance with the error information.

The backlight device may store the average synchronization signal.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram illustrating a generation relationship of a vertical synchronization signal and a pulse width modulation (PWM) signal;

FIG. 2 is a diagram illustrating an example of a PWM signal generated based on a vertical synchronization signal;

FIG. 3 is a diagram illustrating a flicker phenomenon due to jittering of a vertical synchronization signal;

FIG. 4 is a diagram illustrating a flicker phenomenon due to noise applied to a vertical synchronization signal;

FIG. 5 is a diagram illustrating a flicker phenomenon due to brokenness in an ON-time interval of a vertical synchronization signal;

FIG. 6 is a diagram illustrating a configuration of a backlight device according to an exemplary embodiment in the present disclosure;

FIG. 7 is a flowchart illustrating a method of controlling a backlight device according to an exemplary embodiment in the present disclosure;

FIG. 8 is a flowchart illustrating in detail an operation of determining error information and an operation of outputting an output synchronization signal;

FIG. 9 is a diagram illustrating an example of an average synchronization signal y obtained by a reference synchronization signal x; and

FIGS. 10 and 11 are diagrams illustrating examples of a method of adjusting a timing of an average synchronization signal based on a comparison result between a reference synchronization signal and an average synchronization signal.

### DETAILED DESCRIPTION

Exemplary embodiments in the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

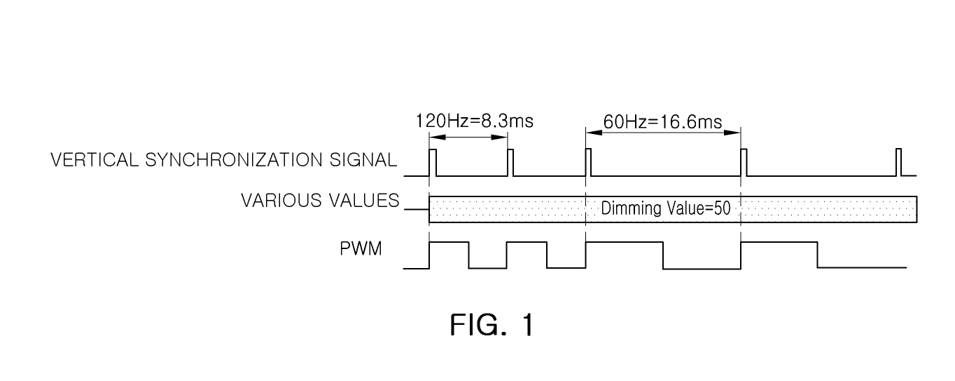

FIG. 1 is a diagram illustrating a generation relationship of a vertical synchronization signal and a pulse width modulation (PWM) signal.

Brightness of a light emitting diode (LED) backlight may be adjusted by a PWM signal. In this case, the PWM signal may have a duty ratio corresponding to an LED dimming value input from an image system of a TV or a liquid crystal display (LCD) timing controller to the LED backlight.

The PWM signal may adjust an LED ON/OFF time by controlling an LED driver apparatus, thereby adjusting brightness of the LED backlight.

The PWM signal of the LED backlight may be generated through being synchronized with an LCD panel. To this end, a vertical synchronization signal Vsync output from an external image system may be used. The vertical synchronization signal Vsync may have various frequencies. In this case, the backlight device may calculate an input period of the vertical synchronization signal for each frame, and may generate the PWM signal proportional to the input period.

Referring to FIG. 1, it may be appreciated that the PWM signal is generated in proportion to the vertical synchronization signal. As illustrated in FIG. 1, although a predetermined dimming value, for example, 50%, is applied, the PWM signal having different periods may be generated based on a frequency of the vertical synchronization signal.

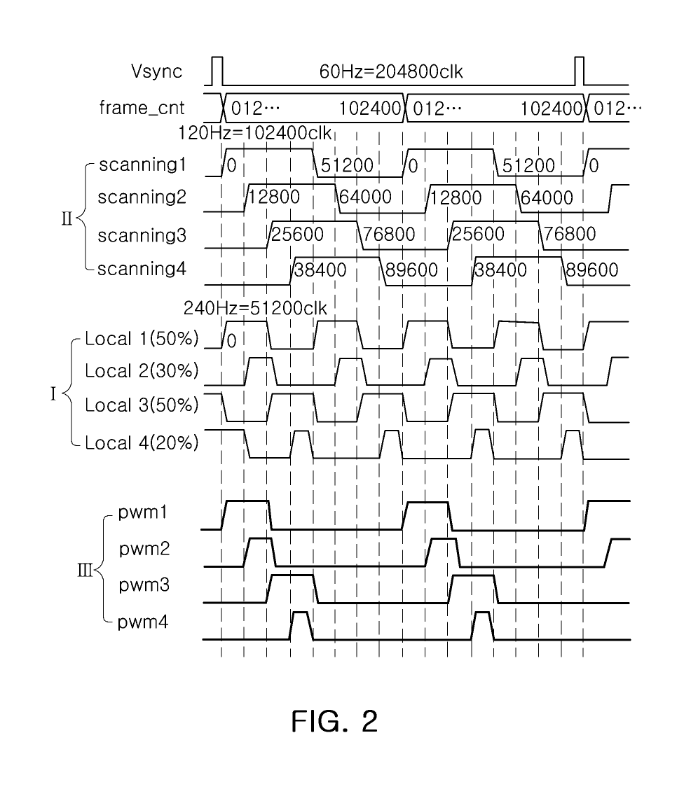

FIG. 2 is a diagram illustrating an example of PWM signals generated based on a vertical synchronization signal.

The I portion of FIG. 2 illustrates PWM signals generated through a local dimming operation. As illustrated in the I portion of FIG. 2, the PWM signals for driving a plurality of LED blocks for corresponding channels may have duty ratios, for example, 50%, 30%, and 20%, based on the corresponding channels, respectively.

Such a duty ratio of the PWM signal may adjust a light emitting time of the plurality of LED blocks. For instance, the light emitting time of the plurality of LEDs may be adjusted based on the duty ratio of the PWM signal.

As a result, the local dimming operation having different levels of brightness for each LED block, for example, a channel, may be performed.

The II portion of FIG. 2 illustrates PWM signals generated through a scanning dimming operation.

As illustrated in the II portion of FIG. 2, the plurality of PWM signals for driving a plurality of LED blocks, for example, channels, may have different delay times, respectively.

That is, the plurality of PWM signals may be input subsequently to being sequentially delayed by first to fourth delay times, respectively, based on a timing at which the vertical synchronization signal Vsync is applied.

As a result, the plurality of LED blocks, channels, of the backlight unit may emit light while being sequentially delayed by the first to fourth delay times for the corresponding channels, respectively, thereby performing the scanning operation in which the plurality of LED blocks are driven at different light emitting timings for the respective channels, as illustrated in the II portion of FIG. 2. In addition, although not illustrated, the LED blocks may simultaneously emit light.

The III portion of FIG. 2 illustrates PWM signals generated through the local dimming and scanning dimming operations.

According to the exemplary embodiment in the present disclosure, the backlight device may output the PWM signals I generated through the local dimming operation and the PWM signals II generated through the scanning dimming operation using a logical AND operation.

As described above, the vertical synchronization signal may be a key reference signal necessary to generate the PWM signal. Therefore, it may be needed to prevent jittering of the vertical synchronization signal or an introduction of noise.

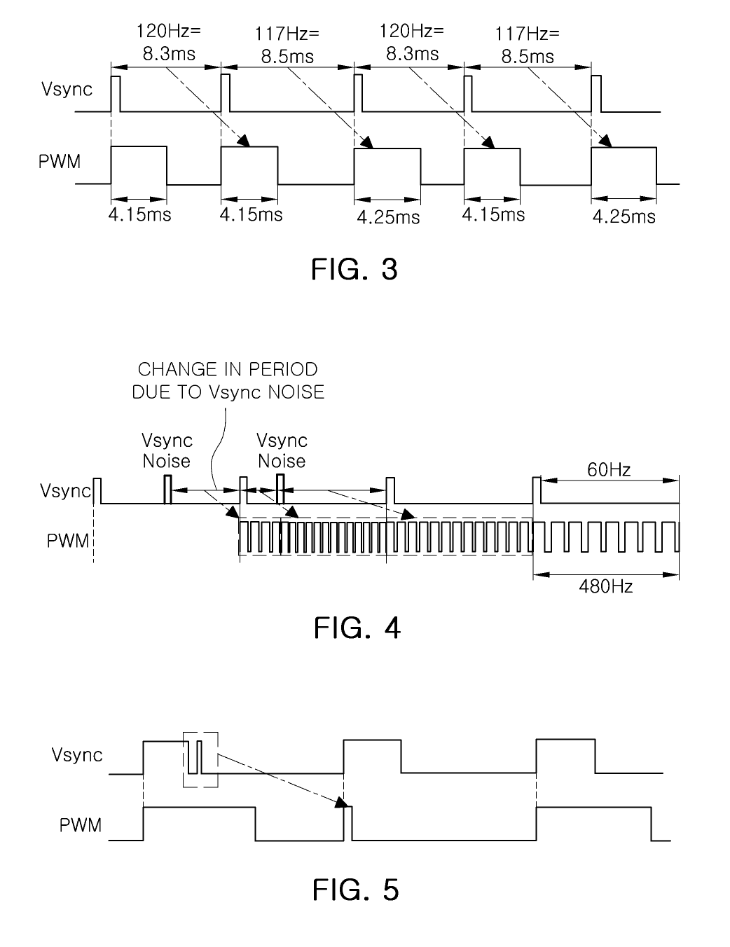

FIG. 3 is a diagram illustrating a flicker phenomenon due to jittering of a vertical synchronization signal.

Referring to FIG. 3, it may be appreciated that changes occur in a pulse period and an ON-time interval of a PWM signal due to a fine jittering phenomenon of a vertical synchronization signal. That is, the ON-time interval of the PWM signal varies from 4.15 milliseconds (ms) to 4.25 ms based on a change in a period of the vertical synchronization signal Vsync, such a phenomenon periodically occurs, and thereby a flicker phenomenon of a periodic screen fluctuation may occur.

FIG. 4 is a diagram illustrating a flicker phenomenon due to noise applied to a vertical synchronization signal.

Referring to FIG. 4, it may be appreciated that changes occur in a pulse period and an ON-time interval of a PWM signal due to noise applied to a vertical synchronization signal Vsync. For example, in a case in which it is intended to generate a PWM signal of 480 hertz (Hz) by applying a vertical synchronization signal Vsync of 60 Hz, 8 PWM signals of 480 Hz having a period of 2.1 ms may need to be generated by dividing 60 Hz, 16.6 ms, by 8.

However, a period of the vertical synchronization signal Vsync may change due to the noise illustrated in FIG. 4. Accordingly, the PWM signal may not be output in a desired manner. As a result, a flicker phenomenon may occur.

FIG. 5 is a diagram illustrating a flicker phenomenon due to brokenness in an ON-time interval of a vertical synchronization signal.

As illustrated in FIG. 5, since a broken portion in an ON-time interval of a vertical synchronization signal may also be recognized as a vertical synchronization signal having a short period, an On-time of a PWM signal generated by the vertical synchronization signal Vsync having the short period may be very short. In a case in which such a phenomenon occurs, a flicker phenomenon of screen flashing may occur in a non-periodic manner.

In order to remove the flickering phenomenon caused by the aforementioned phenomena, the backlight device may need to separately remove noise included in the vertical synchronization signal Vsync in the backlight device without directly using an externally applied vertical synchronization signal.

Meanwhile, in a case in which a timing of a period of the vertical synchronization signal Vsync obtained from the backlight device does not match a period of a synchronization signal used in an image board or a timing controller, image quality may be deteriorated.

Therefore, it is desirable for the backlight device to obtain the vertical synchronization signal having the period matching the period of the synchronization signal of the image board and removed with noise included therein.

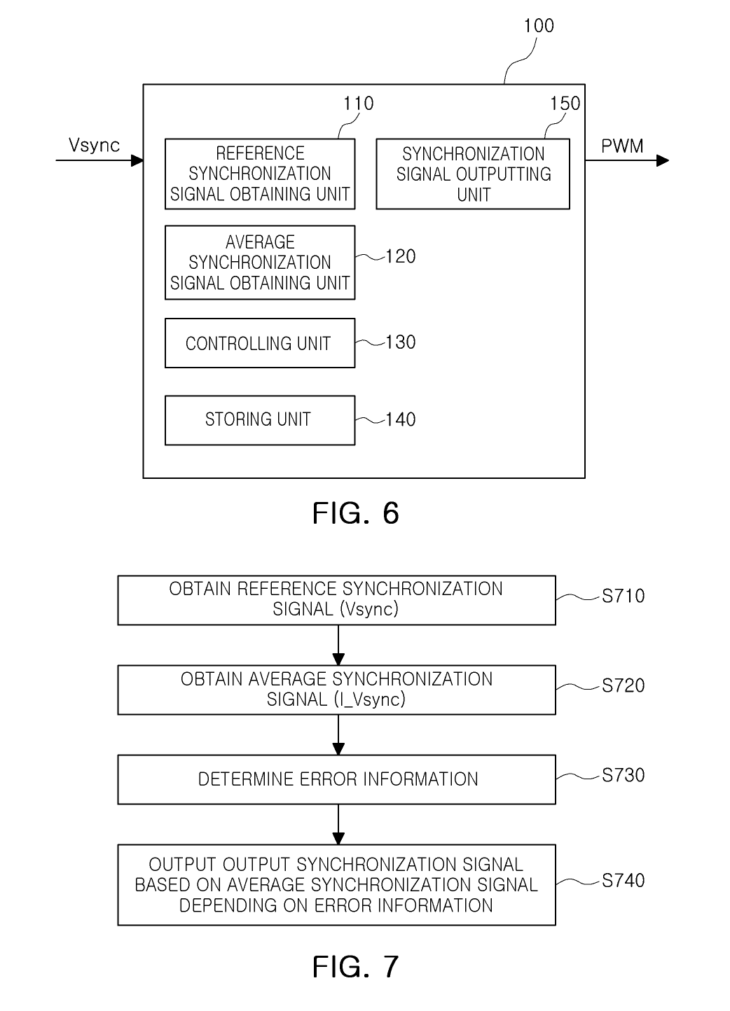

FIG. 6 is a diagram illustrating a configuration of a backlight device according to an exemplary embodiment in the present disclosure.

Referring to FIG. 6, a backlight device 100 may include a reference synchronization signal obtaining unit 110, an average synchronization signal obtaining unit 120, a controlling unit 130, a storing unit 140, and a synchronization signal outputting unit 150.

The backlight device 100 may generate a synchronization signal of an image display device using an LED.

The reference synchronization signal obtaining unit 110 may obtain a reference synchronization signal from another system. For example, the reference synchronization signal obtaining unit 110 may obtain the reference synchronization signal from an image board.

The average synchronization signal obtaining unit 120 may obtain an average synchronization signal based on the reference synchronization signal.

That is, the average synchronization signal obtaining unit 120 may obtain the average synchronization signal, as an example, based on a plurality of pieces of period information in the reference synchronization signal. For example, the average synchronization signal obtaining unit 120 may obtain third period information of the average synchronization signal based on first period information and second period information of the reference synchronization signal. Here, when it is assumed that a period of a reference synchronization signal in a predetermined interval is a first period, a period of a succeeding reference synchronization signal may be defined as a second period. In addition, a period of a reference synchronization signal subsequent to the second period may be defined as a third period.

In detail, the third period information of the average synchronization signal may be determined based on an average value of the first period information and the second period information of the reference synchronization signal.

The controlling unit 130 may determine error information based on at least one of the reference synchronization signal and the average synchronization signal.

As used herein, the error information may collectively refer to information, for example, a flicker error, associated with whether or not a flicker phenomenon of the reference synchronization signal occurs, and a timing error, associated with whether or not a timing difference between the average synchronization signal and the reference synchronization signal occurs, and the like.

For example, the controlling unit 130 may determine whether or not the average synchronization signal is present in a preset range, and may determine that the flicker error is present in the average synchronization signal in a case in which the average synchronization signal is absent in the preset range.

That is, the controlling unit 130 may set the average synchronization signal having an appropriate range in advance based on a predetermined reference synchronization signal. Therefore, the controlling unit 130 may determine that the flicker error is present in the average synchronization signal in the case in which the average synchronization signal is absent in the preset range.

In addition, the controlling unit 130 may compare occurrence timings of the reference synchronization signal and the average synchronization signal with one another. In this case, in a case in which the occurrence timings of the reference synchronization signal and the average synchronization signal do not match, the controlling unit 130 may determine that a timing error is present in the reference synchronization signal.

The storing unit 140 may store period information of the average synchronization signal obtained based on the reference synchronization signal.

The synchronization signal outputting unit 150 may output an output synchronization signal based on the average synchronization signal in accordance with the error information.

For example, the synchronization signal outputting unit 150 may output an average synchronization signal of a previous period or a preset synchronization signal as the output synchronization signal in the case in which the average synchronization signal is absent in the preset range during a predetermined period.

The average synchronization signal of the previous period or the preset synchronization signal may be stored in the storing unit 140.

By using the scheme as described above, the backlight device according to the exemplary embodiment in the present disclosure may prevent the flicker phenomenon.

In addition, the synchronization signal outputting unit 150 may adjust the occurrence timing of the average synchronization signal in the case in which the occurrence timings of the reference synchronization signal and the average synchronization signal do not match. For example, the synchronization signal outputting unit 150 may advance the occurrence timing of the average synchronization signal in a case in which the occurrence timing of the average synchronization signal is subsequent to the occurrence timing of the reference synchronization signal. For example, the synchronization signal outputting unit 150 may retard the occurrence timing of the average synchronization signal in a case in which the occurrence timing of the average synchronization signal is prior to the occurrence timing of the reference synchronization signal.

By using the scheme as described above, the backlight device may prevent image quality deterioration by matching the timings of the synchronization signal used in the image board or the timing controller and the synchronization signal output from the backlight device.

FIG. 7 is a flowchart illustrating a method of controlling a backlight device according to an exemplary embodiment in the present disclosure.

According to an exemplary embodiment in the present disclosure, in operation S710, the backlight device 100 may obtain a reference synchronization signal Vsync from an image board, or the like.

In addition, in operation S720, the backlight device 100 may obtain an average synchronization signal I_Vsync based on the reference synchronization signal Vsync.

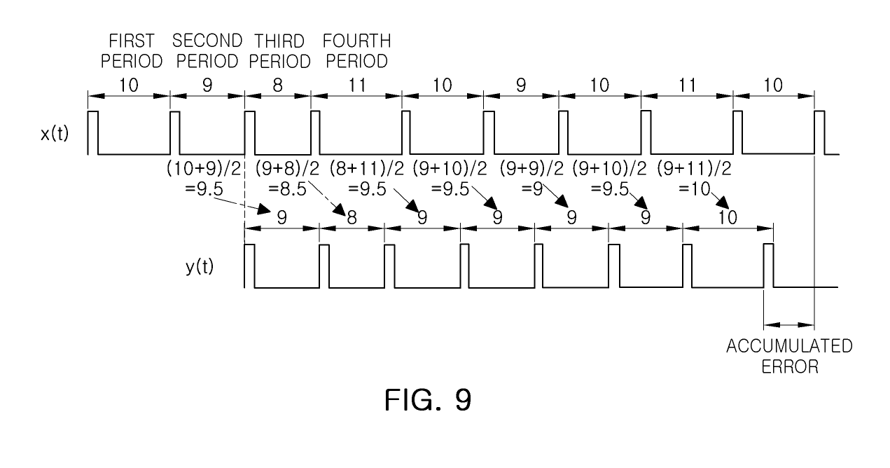

FIG. 9 is a diagram illustrating an example of an average synchronization signal y obtained based on a reference synchronization signal x.

Referring to FIG. 9, the backlight device 100 may obtain third period information of the average synchronization signal based on first period information and second period information of the reference synchronization signal. Here, when it is assumed that a period of a reference synchronization signal in a predetermined interval is a first period, a period of a succeeding reference synchronization signal may be defined as a second period. In addition, a period of a reference synchronization signal next to the second period may be defined as a third period.

In detail, the third period information (for example, 9 ms) of the average synchronization signal may be determined by an average value (for example, (10 ms+9 ms)/2) of the first period information (for example, 10 ms) and the second period information (for example, 9 ms) of the reference synchronization signal. For example, the numeral below a decimal point of the average value may be discarded.

By using the scheme as described above, fourth period information (for example, 8 ms) of the average synchronization signal may be determined by an average value (for example, (9 ms+8 ms)/2) of the second period information (for example, 9 ms) and the third period information (for example, 8 ms) of the reference synchronization signal.

Meanwhile, according to the exemplary embodiment in the present disclosure, in operation S730, the backlight device 100 may determine error information based on at least one of the reference synchronization signal and the average synchronization signal. In addition, in operation S740, the backlight device 100 may output an output synchronization signal based on the average synchronization signal in accordance with the error information.

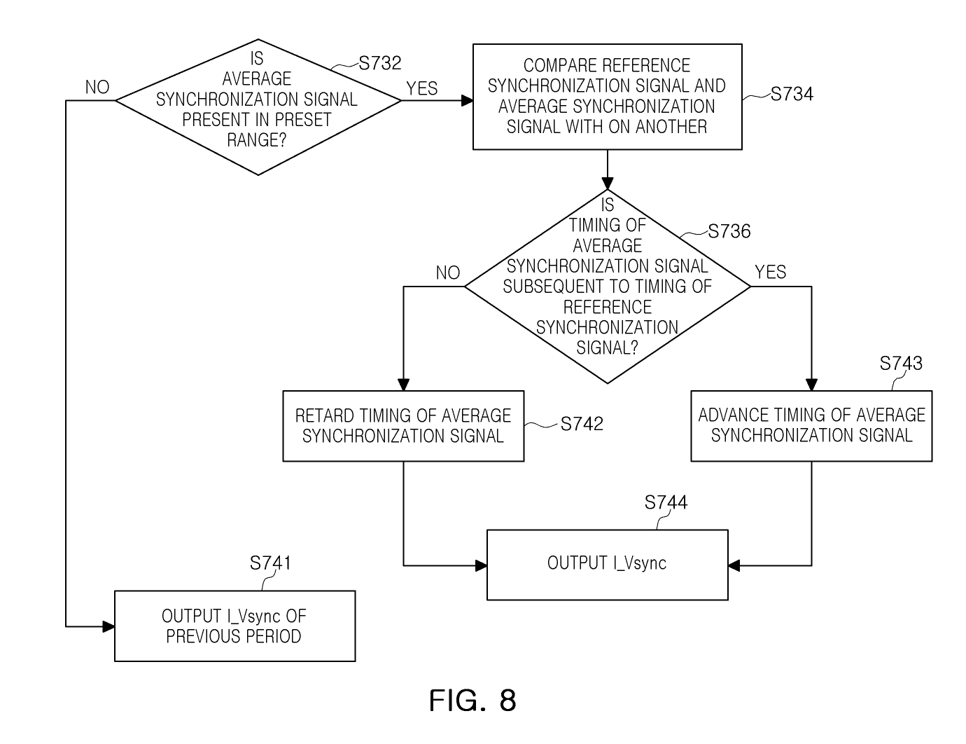

FIG. 8 is a flowchart illustrating in detail an operation of determining error information and outputting an output synchronization signal.

Referring to FIG. 8, in operation S732, the backlight device 100 may determine whether or not the obtained average synchronization signal is present in a preset range.

The backlight device 100 may set an average synchronization signal having an appropriate range in advance based on a predetermined reference synchronization signal. Therefore, the backlight device 100 may determine that a flicker error is present in the average synchronization signal in a case in which the average synchronization signal is absent in the preset range. For example, the backlight device 100 may determine whether or not the average synchronization signal is present in the preset range, and may determine that the flicker error is present in the average synchronization signal in the case in which the average synchronization signal is absent in the preset range.

According to the exemplary embodiment in the present disclosure, the backlight device 100 may output an average synchronization signal of a previous period or a preset synchronization signal as the output synchronization signal in the case in which the average synchronization signal is absent in the preset range at a predetermined period (S741).

By using the scheme as described above, the backlight device according to the exemplary embodiment in the present disclosure may prevent the flicker phenomenon.

Meanwhile, since the average synchronization signal is generated based on the average value of the period information of the reference synchronization signal, an accumulated error illustrated in FIG. 9 may occur. Such an accumulated error may cause a timing error between the reference synchronization signal and the average synchronization signal, thereby resulting in image quality deterioration. Moreover, due to the above-mentioned accumulated error, the timing error between the reference synchronization signal and the average synchronization signal may be continuously or cumulatively increased over time. Since such a timing error continuously changes synchronization between an operation of a liquid crystal of an LCD panel and the backlight device without fixing the synchronization therebetween, it may cause an error in a screen in which ON/OFF operations slowly repeat in a periodic manner.

In order to prevent such an error, the backlight device 100 according to the exemplary embodiment in the present disclosure may compare the reference synchronization signal and the average synchronization signal with each other in operation S734, and may check whether or not a timing of the average synchronization signal is prior to a timing of the reference synchronization signal in operation S736.

According to the exemplary embodiment in the present disclosure, in a case in which the timing of the average synchronization signal is prior to the timing of the reference synchronization signal, the backlight device 100 may retard the timing of the average synchronization signal in operation S742, and may output an output synchronization signal I_Vsync in operation S744.

In addition, in a case in which the timing of the average synchronization signal is subsequent to the timing of the reference synchronization signal, the backlight device 100 may advance the timing of the average synchronization signal in operation S743, and may output the output synchronization signal I_Vsync in operation S744.

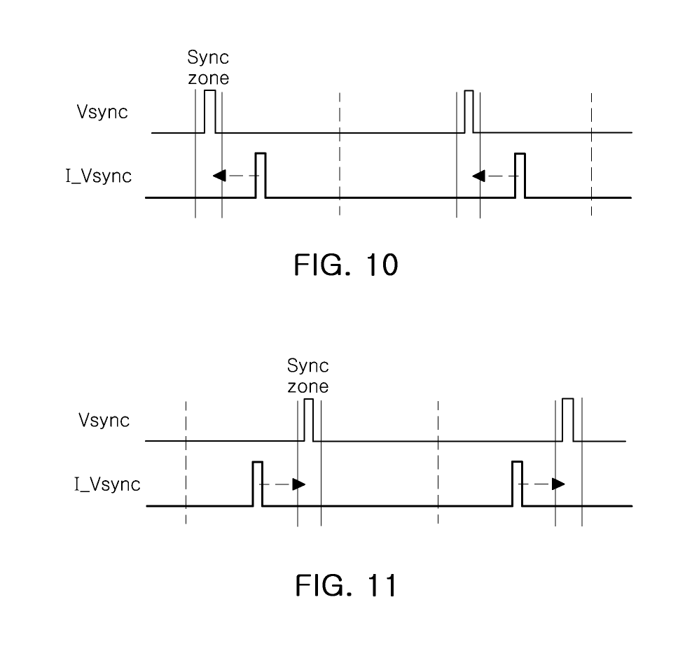

FIGS. 10 and 11 are diagrams illustrating examples of a method of adjusting a timing of an average synchronization signal based on a comparison result between a reference synchronization signal and the average synchronization signal.

The backlight device 100 may set a sync zone in the vicinity of an On-time of a reference synchronization signal Vsync. In addition, the backlight device 100 may adjust a timing of an average synchronization signal I_Vsync by a preset degree in a periodic manner, for example, 8 microseconds (μs), in a case in which the timing of the average synchronization signal I_Vsync deviates from the sync zone of the reference synchronization signal Vsync due to an accumulated error, or the like. Through the process described above, the timing of the average synchronization signal I_Vsync may be synchronized with the timing of the reference synchronization signal Vsync.

It may be desirable that a degree of timing to be adjusted may correspond to that allowing a flicker phenomenon to be indiscernible to the human eye.

Referring to FIG. 10, in a case in which the timing of the average synchronization signal I_Vsync is subsequent to the timing of the reference synchronization signal Vsync, the backlight device 100 may advance the timing of the average synchronization signal I_Vsync by a preset degree.

Referring to FIG. 11, in a case in which the timing of the average synchronization signal I_Vsync is prior to the timing of the reference synchronization signal Vsync, the backlight device 100 may retard the timing of the average synchronization signal I_Vsync by the preset degree.

As set forth above, according to some exemplary embodiments in the present disclosure, the backlight device and the control method thereof may be capable of preventing the flicker phenomenon.

Additionally, the backlight device and the control method thereof may be capable of being synchronized with the image board.

Further, the backlight device and the control method may be capable of obtaining the synchronization signal less affected by noise.

While exemplary embodiments have been shown and described above, it will be apparent to those skilled in the art that modifications and variations could be made without departing from the scope of the present invention as defined by the appended claims.

What is claimed is:

1. A method of controlling a backlight device for generating a synchronization signal of the backlight device using a light emitting diode, the method comprising:
obtaining a reference synchronization signal;
obtaining an average synchronization signal based on the reference synchronization signal;
determining error information based on at least one of the reference synchronization signal and the average synchronization signal; and
outputting an output synchronization signal based on the average synchronization signal in accordance with the error information.

2. The method of claim 1, wherein the obtaining of the average synchronization signal includes obtaining the average synchronization signal based on a plurality of pieces of period information in the reference synchronization signal.

3. The method of claim 2, wherein the obtaining of the average synchronization signal includes obtaining third period information of the average synchronization signal based on first period information and second period information in the reference synchronization signal.

4. The method of claim 1, wherein the determining of the error information includes determining whether or not the average synchronization signal is present in a preset period.

5. The method of claim 4, wherein the outputting of the output synchronization signal includes outputting the output synchronization signal based on at least one of an average synchronization signal of a previous period and a preset synchronization signal in a case in which the average synchronization signal is absent in the preset period.

6. The method of claim 1, wherein the determining of the error information includes comparing the reference synchronization signal and the average synchronization signal with each other.

7. The method of claim 6, wherein the outputting of the output synchronization signal includes advancing an occurrence timing of the average synchronization signal in a case in which an occurrence timing of the average synchronization signal is subsequent to an occurrence timing of the reference synchronization signal.

8. The method of claim 6, wherein the outputting of the output synchronization signal includes retarding an occurrence timing of the average synchronization signal in a case in which an occurrence timing of the average synchronization signal is prior to an occurrence timing of the reference synchronization signal.

9. A backlight device for generating a synchronization signal of an image display device using a light emitting diode, the backlight device comprising:
a reference synchronization signal obtaining unit obtaining a reference synchronization signal;
an average synchronization signal obtaining unit obtaining an average synchronization signal based on the reference synchronization signal;
a controlling unit determining error information based on at least one of the reference synchronization signal and the average synchronization signal; and
a synchronization signal outputting unit outputting an output synchronization signal based on the average synchronization signal in accordance with the error information.

10. The backlight device of claim 9, further comprising a storing unit storing the average synchronization signal.
